(19) United States
(12) Patent Application Publication
(10) Pub. No.: US 2025/0314235 A1
(43) Pub. Date: Oct. 9, 2025

(54) OFFSHORE ENERGY HARVESTER

(71) Applicant: The Regents of the University of Michigan, Ann Arbor, MI (US)

(72) Inventors: Kartik Praful Naik, Livonia, MI (US); Jing Sun, Superior Township, MI (US); Lei Zuo, Ann Arbor, MI (US)

(21) Appl. No.: 19/173,790

(22) Filed: Apr. 8, 2025

Related U.S. Application Data
(60) Provisional application No. 63/631,533, filed on Apr. 9, 2024.

(51) Int. Cl. F03D 5/00; F03B 17/06

(52) U.S. Cl. CPC F03D 5/00; F03B 17/06

(57) ABSTRACT

An energy harvester simultaneously generates electrical energy from more than one source of natural fluidic motion, including wind motion and water motion. The energy harvester includes a wind turbine generator, a hydrokinetic turbine generator, or a wave energy generator. The impedance of the generators can be modulated to selectively control pitch, roll, and yaw motions of the energy harvester to stabilize external forces on the energy harvester and/or control the orientation of the energy harvester with respect to a wind direction or water movement direction. The generators may thus synergistically serve the dual purposes of electrical energy generation and energy harvester stability control.

### TECHNICAL FIELD

This disclosure is related to energy harvesters that convert fluidic motion to electrical energy.

### BACKGROUND

Offshore wind farms have seen a recent surge in development activity, due in part to the relatively high wind speeds and proximity to big cities. Currently, most of these include fixed-bottom wind turbines anchored to the ocean floor. However, the cost and logistics of anchoring the base of a wind turbine to the ocean floor or a lakebed is problematic, and the distance of such turbines from the shoreline is limited due to the water depth at which it is possible to anchor their bases. While there has been some interest in floating wind turbines, their multiple degrees of freedom of movement are problematic in terms of stability.

### SUMMARY

Embodiments of an energy harvester simultaneously generate electrical energy from more than one source of natural fluidic motion.

Embodiments of a floatable energy harvester include at least one electrical generator, wherein each generator is controllable to stabilize energy harvester motion.

Each energy harvester may include one or more of the following features in any technically feasible combination:
a first generator that generates electrical energy from wind and a second generator that generates electrical energy from natural water motion;
a wind turbine generator and a hydrokinetic turbine generator;
a controller configured to modulate an impedance of the hydrokinetic turbine generator to orient the wind turbine to face a wind direction;
a wind turbine generator and a wave energy generator;
a plurality of generators, each generator being configured to generate electrical energy from a different one of the sources of natural fluidic motion;
a controller configured to stabilize motion of the energy harvester by modulating an impedance of each generator;
an impedance of each generator is modulated by modulating an electrical load on the respective generator;
at least one sensor that provides energy harvester motion information to the controller;
at least one sensor that provides information related to pitch, roll, and yaw of the energy harvester;
a plurality of hydrokinetic turbine generators that are individually controllable to change an orientation of the energy harvester with respect to wind direction;
at least one electrical generator includes at least two of: a wind turbine generator, a hydrokinetic turbine generator, or a wave energy generator.

Embodiments of a floatable energy harvester include a platform, a plurality of electrical generators supported by the platform, at least one sensor, and a controller. The generators include a wind turbine generator supported above the platform, hydrokinetic turbine generators supported below a water line of the energy harvester, and wave energy generators supported along a perimeter of the platform. The at least one sensor continuously detects at least one direction of movement of the energy harvester, and the controller receives energy harvester motion information from the at least one sensor and modulates an electrical load on each generator to stabilize motion of the energy harvester. The controller is configured to modulates the electrical load on: the wind turbine generator to stabilize pitching motion of the energy harvester, the hydrokinetic turbine generators to stabilize pitching motion, rolling motion, or yawing motion of the energy harvester, and/or the wave energy generators to stabilize pitching motion or rolling motion of the energy harvester. The controller may modulate an impedance differential among the hydrokinetic turbine generators to change an orientation of the energy harvester.

Embodiments of a method of stabilizing motion of a floating energy harvester include modulating an impedance of at least one electrical generator of the energy harvester.

The floating energy harvest may include one or more of the above-listed features in any technically feasible combination, and the method may include one or more of the following features in any technically feasible combination:
modulating the impedance includes modulating an electrical load on the at least one electrical generator;
modulating the impedance of a wind turbine generator to stabilize pitching motion of the energy harvester;
modulating the impedance of a hydrokinetic turbine generator to stabilize pitching motion, rolling motion, or yawing motion of the energy harvester;
modulating the impedance of a wave energy generator to stabilize pitching motion or rolling motion of the energy harvester;
modulating an impedance differential among a plurality of electrical generators to affect an orientation of the energy harvester with respect to a wind direction.

### BRIEF DESCRIPTION OF THE DRAWINGS

FIG. 1 is a perspective view of an energy harvester including a wind turbine generator, hydrokinetic turbine generators, and wave energy generators.

FIG. 2 is a side and partial cross-sectional view of an example of the wave energy generator of FIG. 1.

FIG. 3 is the view of FIG. 1 illustrating pitch, roll, and yaw directions of the energy harvester.

FIG. 4 is a side view of the energy harvester of FIG. 1 exhibiting pitching motion in a body of water.

FIG. 5 is a front view of the energy harvester of FIG. 4 exhibiting rolling motion.

FIG. 6 is a top view of the energy harvester of FIGS. 4 and exhibiting yawing motion.

FIG. 7 is a perspective view of the energy harvester of FIG. 1 with different wave energy generators.

FIG. 8 is a schematic view of system including the energy harvester of FIG. 1.

### DESCRIPTION OF EMBODIMENTS

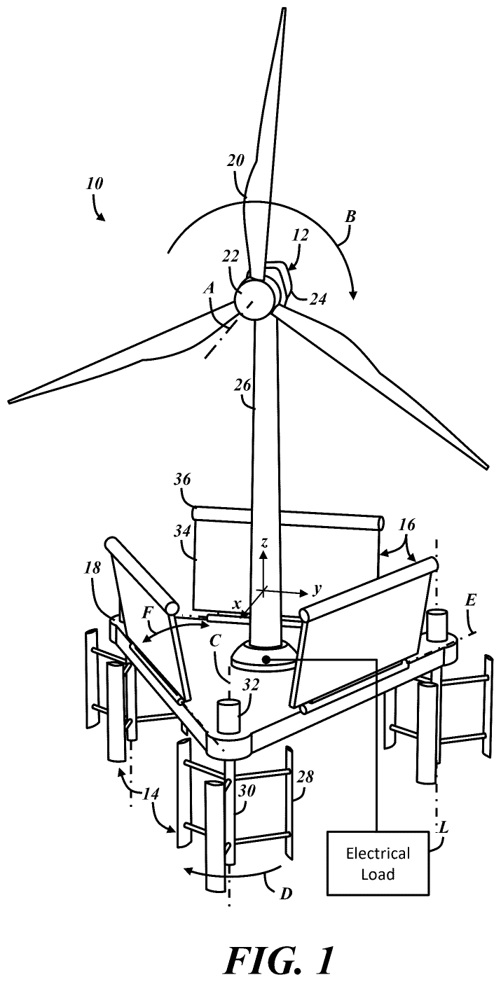

Described below is an energy harvester that generates electrical energy from more than one source. A floatable version of the energy harvester can also self-stabilize by modulating the impedance of its electrical generators. Sources of natural fluidic motion include natural motions of water, including water currents and wave motion, and natural motions of air, including wind currents. With reference to FIG. 1, an illustrative energy harvester 10 includes at least one generator 12 that generates electricity from wind and/or at least one generator 14, 16 that generates electricity from water movement in a body of water, such as an ocean, lake, or river. As used here, “generator” is used in its literal sense as a device that generates electrical energy from a different form of energy, which in this case is the kinetic energy of fluids carried by wind or water. The term “generator” is not limited to direct current generators and is intended to encompass alternators, for example. The energy harvester 10 may be a floatable offshore energy harvester configured to be tethered to the floor or bed of a body of water. In the illustrated example, the energy harvester 10 includes a single wind turbine generator 12 mounted to and supported above a platform or base 18, along with a plurality of hydrokinetic turbine generators 14 and a plurality of wave energy generators 16 mounted to and supported by the platform 18.

The wind turbine generator 12 includes turbine blades 20 mounted to a hub 22 for rotation about a wind turbine axis A in response to air currents flowing over the blades. The blades 20 and hub 22 together form a motion converter that converts generally horizontal atmospheric air motion to rotational motion of the blades 20 and hub 22 in the B direction of FIG. 1. The location and orientation of the wind turbine axis A may be fixed with respect to the platform 18 and aligned with an x-axis of the energy harvester 10, which is a horizontal axis when the energy harvester is at rest. Rotation of the blades 20 and hub 22 causes relative rotation of a rotor and stator in a housing 24 of the wind turbine generator 12, inducing a voltage in the stator windings and a corresponding electric current when connected to an electrical load L. The generator 12 is supported above the platform 18 by a structural post 26 extending generally perpendicular to the platform 18 or a reference plane of the platform-in the z-direction of FIG. 1, which is vertical when the energy harvester 10 is at rest. The post 26 may also extend below the platform. The post 26 may house electrical conductors (e.g., wires) to transmit electric current from the generator 12 to a power control hub (not shown) that receives and manages power provided by the multiple distinct electrical generators 12-16 and its ultimate transmission to an electrical grid or storage system, represented schematically in FIG. 1 as electrical load L on the energy harvester generators.

Each hydrokinetic turbine generator 14 includes turbine blades 28 mounted to a hub 30 for rotation about a hydrokinetic turbine axis C in response to water currents flowing over the blades. Each axis C is parallel with the z-axis in this example. The blades 28 and hub 30 together form a motion converter that converts generally linear water motion to rotational motion of the hub 30 in the D direction of FIG. 1. The location and orientation of each hydrokinetic turbine axis C may be fixed with respect to the platform 18. Rotation of the hub 30 causes relative rotation of a rotor and stator in a housing 32 of the respective generator 14 to generate electric power. In this example, the blades 28 and hub 30 of each generator 14 are supported below the platform 18, while the generator housing 32 is supported above the platform. Electrical conductors transmitting electric current from each generator 12 to the power control hub may be housed in or along the platform 18.

Each wave energy generator 16 in this example includes an oscillating surge wave energy converter (OSWEC) including a paddle 34 mounted for pivotable motion about a pivot axis E in response to wave motion along the surface of a body of water. Each pivot axis E is in an x-y plane along a respective edge of the platform 18. The paddles 34 extend generally vertically from the pivot joint. In this example, each wave energy generator 16 includes a float 36 spaced away from the pivot axis E and at a distal end of the respective paddle 34. The floats 36 provide the energy harvester 10 with buoyancy such that the floats are positioned at the water surface when the energy harvester is in a body of water. Each paddle 34 and float 36 forms a motion converter that converts horizontal and vertical wave motion to oscillatory rotational motion of the paddle 34 in the F direction of FIG. 1. The leading side of a wave pushes the float end of the paddle 34 in a first rotational direction about the pivot axis E, and then the paddle pivots in the opposite rotational direction while in the trough between successive waves. The location and orientation of each pivot axis E may be fixed with respect to the platform 18 and perpendicular with a radial direction extending from the center of the platform 18. In this example, the paddle 34 of each generator 16 is positioned above the platform 18.

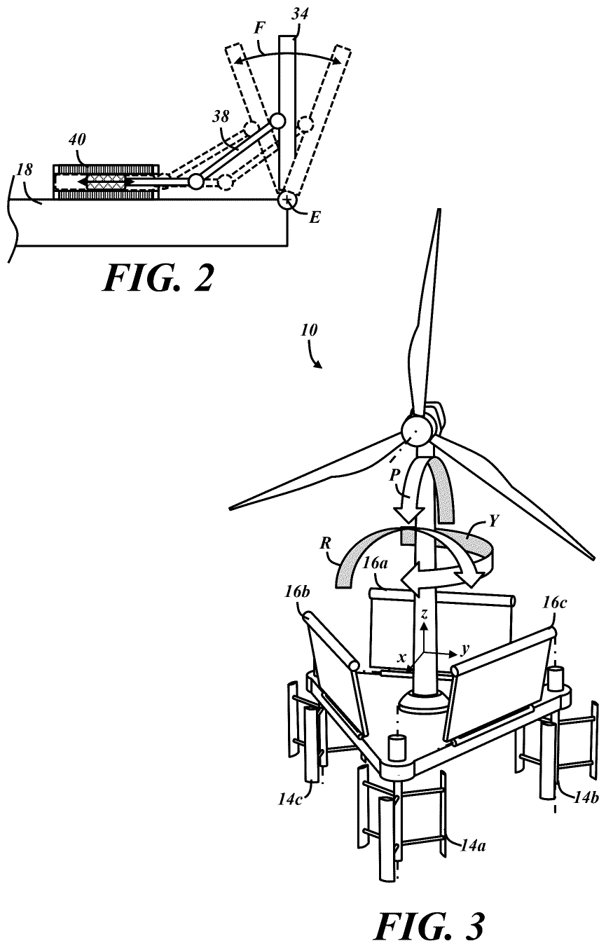

Each paddle 34 is coupled with a power takeoff (PTO) that converts the wave energy captured by the paddle into a different form of energy, such as electrical energy. In the example of FIG. 2, a linkage 38 (e.g., a hydraulic cylinder) with pivot joints on both ends interconnects a face of the paddle 34 with a permanent magnet of a linear generator 40 to provide electrical energy. Other PTOs may employ a rotary electric generator. For example, a shaft defining the pivot axis E can include a gear that engages a rotary generator directly, a belt or pulley system affixed to the paddle can engage and drive a rotary generator, or the linear generator 40 of FIG. 2 can be replaced with a ball screw or a piston/hydraulic motor to turn a rotary generator, to name a few examples.

The illustrated platform 18 has a triangular shape in an x-y plane, and the water motion generators 14, 16 are arranged about the platform with rotational symmetry with one hydrokinetic turbine 14 at each vertex of the triangle and one wave energy generator 16 along each edge of the triangle. While a triangular shape may be preferred for reasons of structural integrity and/or efficiency, other polygonal shapes are possible with the water motion generators symmetrically spaced about the perimeter of the platform 18. Circular or other round-perimeter platforms are also possible. It is also noted that the depicted energy harvester 10 is largely schematic to demonstrate the concept. For instance, the platform 18 and/or the paddles 34 of the wave energy generators 16 can be made with non-solid surfaces in some cases to allow some water flow through them. Also, while the illustrated wind turbine generator 12 is located at the center of the platform 18, it may be located elsewhere along the platform, such as at a vertex of the platform shape.

Due to the floatable nature of the illustrated example, and subject to the limitations of tethers between the bottom of the body of water and the energy harvester 10, movement of the energy harvester has all six degrees of freedom of motion in translation and rotation, including pitching motion P in a vertical x-z plane, rolling motion R in a vertical y-z plane, and yawing motion Y in a horizontal x-y plane, as depicted in FIG. 3. FIG. 3 also includes individual reference numerals for the hydrokinetic turbine generators 14a-14c and the wave energy generators 16a-16c for ease in discerning their respective locations in the subsequent figures.

The employment of multiple different modes of energy transformation by the different types and orientations of electrical generators 12-16 enable the energy harvester 10 to be at least partially self-stabilizing in that the impedance of the generators can be modulated to counteract destabilizing forces on the energy harvester. As used herein, “impedance” means “resistance to movement.” For each electrical generator 12-16, the impedance is a function of the electrical load placed on the generator—i.e., an increased electrical load on the electrical output of a generator results in an increased resistance to the generator's electrical power-generating motion. As described further below, modulating the impedance of the generators affects reactionary forces, moments, and momentum imparted on the platform by each generator. This means that the stability and motion of the platform can be actively controlled by controlling the electrical load on each generator 12-16. It should be noted that, while modulation of the electrical load on the generators 12-16 of the energy harvester may be the preferred method of modulating their respective impedances, generator impedance can be modulated in other ways, including the use of braking mechanisms, controlled damping systems, etc.

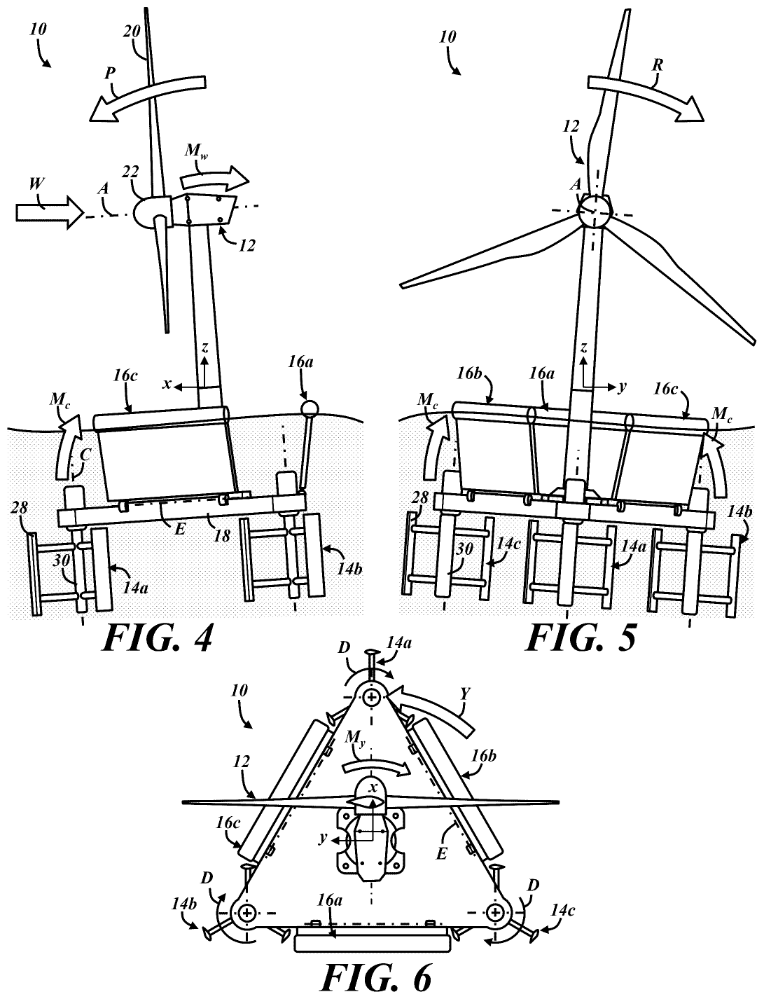

In the side view of FIG. 4, two of the hydrokinetic turbine generators 14a, 14b are visible, and the third generator 14c is behind generator 14b. Two of the wave energy generators 16a, 16c are also visible, and the third generator 16b is behind generator 16c. In FIG. 4, the energy harvester 10 is facing into the wind W, causing the blades 20 and hub 22 of the wind turbine generator 12 to rotate about their axis A in direction B (FIG. 1). Some of the wind energy results in a net force on the front face of the blades 20 and hub 22, resulting in a wind moment M_{w} on the energy harvester 10 in the direction indicated in FIG. 4. The magnitude of the wind moment M_{w} can be controlled to some degree by modulating the impedance of the wind turbine 12. When the impedance of the wind turbine is increased, there is an increased resistance to rotation of the hub 22 about its axis A. That increased resistance to rotation causes the wind moment M_{w} to increase. Conversely, when the impedance of the wind turbine 12 is decreased, the wind moment M_{w} is decreased.

In the example of FIG. 4, the energy harvester 10 is on the trailing side of a wave that is traveling in the same direction as the wind W and is experiencing forward pitching motion P due to the wave—i.e., the front of the wind turbine 12 facing toward the wind W is rotated toward the earth in a direction opposite that of the wind moment M_{w}. Increasing the impedance of the wind turbine hub 22 while the energy harvester 10 is in the illustrated orientation—or when the pitching motion P away from vertical is first detected—can help stabilize the energy harvester against the pitching motion. Likewise, when the energy harvester 10 encounters the leading side of a subsequent wave and experiences rearward pitching motion in the same direction as the wind moment M_{w}, decreasing the impedance of the wind turbine can help reduce the magnitude of the rearward pitching motion. Of course, not all pitching motion requires stabilization. To maximize electric power generation, the wind turbine generator 12 may be fully loaded by the electrical load L until the pitching motion P reaches a threshold instability value, for example.

The water motion generators 14, 16 can also have an effect on the pitching motion P of the energy harvester 10. For instance, water current-induced rotation of the blades 28 and hub 30 of each hydrokinetic turbine generator 14 about its respective axis C causes a water current moment M_{c} on the energy harvester at each hydrokinetic generator. For simplicity in explanation, a water current moment M_{c} is shown only at hydrokinetic generator 14a in this example. In the particular orientation of FIG. 4, the illustrated water current moment M_{c} at the forward-most generator 14a is a pitching moment in the same direction as the wind moment M_{w}. In this case, increasing the impedance of the generator 14a causes it to turn slower, which reduces the water current moment M_{c}. Decreasing the impedance of the generator 14a causes it to turn faster, which increases the water current moment M_{c}. The water current moment M_{c} is generally less than the wind moment M_{c} due to relative distances of the respective generators 12, 14 from the center of rotation of the energy harvester and the different principle of operation of each. With the energy harvester 10 pitched forward as in FIG. 4, increasing the rotational speed of the turbine blades 28 and hub 30 by decreasing the impedance (e.g., removing electrical load) will counteract the pitching motion P of the energy harvester.

With the hydrokinetic turbine generators 14a-14c symmetrically arranged about the platform 18, the net water current moment M_{c} on the energy harvester is zero when all of the generators 14a-14c are turning at the same speed. Also, when the two generators 14b, 14c on the rearward corners of the platform in FIG. 4 are rotating, they impose individual water current moments M_{c} that are partially pitching moments and partially rolling moments and can therefore be used to help counteract rolling motion R of the energy harvester 10 as well as pitching motion P. When the hydrokinetic turbine generators 14 are turning at different speeds, whether because of their respective positions in the water current or because of intentional impedance modulation, a net water current moment with a pitching component and a rolling component can be determined, and the direction and magnitude of the net water current moment can be modulated via impedance control of the individual generators 14a-14c. This is also true for the wave energy generators 16a-16c.

Because of the oscillatory motion of the wave energy generators 16a-16c, and because of their plurality of different orientations with respect to the x-y plane, increased impedance of those generators 16 decreases both pitching and rolling motion of the energy harvester 10. Likewise, the wave energy generators 16 provide stability in translation in the x-y plane while pivoting in either direction about their respective axes E. Nonetheless, their impedance can also be modulated to affect the net moment on the energy harvester 10 as desired.

FIG. 5 illustrates rolling motion R of the energy harvester 10. While there may be a minor component of rolling moment associated with the wind turbine 12, it is omitted in FIG. 5. FIG. 5 illustrates the water current moment M_{c} for each of the two rearward hydrokinetic generators 14b, 14c, each of which has a major rolling component and a minor pitching component. The forwardmost hydrokinetic generator produces no rolling moment. The illustrated rolling motion R of the energy harvester 10 can be counteracted by increasing the rotational speed of one rearward generator 14b and/or decreasing the rotational speed of the other rearward generator 14c. This may involve respectively decreasing and increasing the electrical load on each generator 14b, 14c. As already noted, the oscillatory motion of the wave energy generators 16a-16c combined with their plurality of different orientations with respect to the x-y plane generally decreases both pitching and rolling motion of the energy harvester 10 with increased impedance.

FIG. 6 is a top view of the energy harvester 10 illustrating yawing motion of the harvester. Generally, rotation of the multiple hydrokinetic turbines 14a-14c results in a yawing moment M_{y} on the energy harvester 10 with its direction and magnitude being dependent on the relative rotational speeds of each individual turbine 14a-14c and the direction of the water current turning the turbines 14. Generally, increasing an impedance differential among the generators 14a-14c will increase the yawing moment M_{y}, while decreasing the impedance differential among the generators will decrease the yawing moment. The direction of the yawing moment My can be controlled by selecting the proper turbine on which to increase or decrease the impedance. Accordingly, a yawing moment Y imposed on the energy harvester 10 by external forces can be counteracted, at least in part, via modulation of the impedance of the hydrokinetic turbine generators 14a-14c.

In some cases, modulation of the impedance of the hydrokinetic turbine generators 14 can be used to intentionally rotate the energy harvester 10 about its z-axis to align the wind turbine generator 12 with the wind direction to maximize or increase electric energy production, for example, or to reduce tension on the mooring system. In a specific example, the naturally imposed yawing motion Y can be permitted to rotate the energy harvester 10 about its z-axis by increasing the impedance differential among the hydrokinetic generators 14a-14c, and then the impedance differential among those same generators can be decreased to stabilize the energy harvester 10 in the desired orientation.

Of course, stabilization of the energy harvester 10 in real-world use is not as simple as the single degree-of-freedom examples depicted in FIGS. 4-6. But these examples do provide the basis to enable a person having ordinary skill in the art to make and use a multi-source energy harvester in which the energy-harvesting generators can be used as stabilizing elements. Any number of different types of energy-harvesting generators can be used, with each providing a determinable moment on the system that can be modulated to stabilize the harvester against moments externally imposed by wind and water motion.

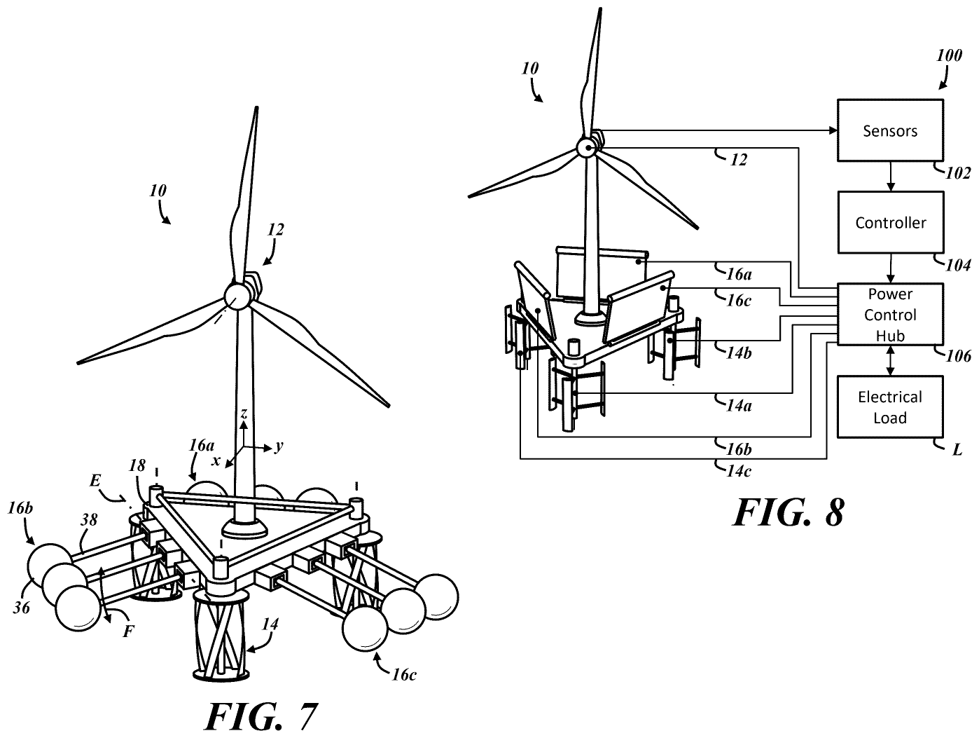

FIG. 7 depicts another embodiment of the energy harvester 10 equipped with different wave energy generators 16 in which oscillatory motion drives the electric power generation. In this example, the wave energy generators 16 employ point absorber-type wave energy converters (WECs). Each energy converter includes a spherical float 36 at a distal end of an elongate pole 38. There is a group of multiple energy converters arranged along each side of the platform 18 with the groups arranged symmetrically, but with the individual energy converters of each group able to move independently from one another. The oscillatory motion of these energy converters about the pivot axes E is primarily vertical as each float 36 passes over a wave. Due to the multiple energy converters in each group, there are more combinations of moments imparted on the platform 18. For instance, the center float 36 of the rearward group 16a provides a pure pitching moment to the energy harvester 10, while the other two floats of the rearward group 16a provide a moment that is primarily in pitch but with a small rolling component. This can offer more precise control of the generator-associated moments to stabilize the energy converter 10 against the external moments imposed by the wind, waves, and water currents. Modulating the impedance of these wave energy generators 16 can affect the rolling and pitching movements of the energy harvester 10. For example, if the energy harvester 10 is exhibiting rearward pitching motion, an increased impedance on wave energy generator group 16a can counteract that movement. If the energy harvester 10 is exhibiting forward pitching motion, an increased impedance on wave energy generator groups 16b, 16c can counteract that movement while also providing resistance to rolling motions. This embodiment may include additional float elements affixed to the platform since it does not rely on the wave energy converters for buoyancy.

With reference to FIG. 8, a system 100 for implementing a method of operation of the energy harvester 10 is schematically illustrated. At least part of the system 100 is an integral part of the energy harvester 10. Here, the system 100 includes one or more sensors 102, a controller 104, and a power control hub 106, all of which are on-board components of the energy harvester. The one or more sensors 102 includes at least one sensor that provides information related to pitch, roll, and yaw of the energy harvester 10, such as an inertial measurement unit (IMU). Other sensors 102 may include a wind speed and/or wind direction sensor, encoders or rotational speed sensors for each of the generators 12-16, and/or power sensors for monitoring voltage and/or current produced by each generator.

The controller 104 may be a microprocessor-based controller programmed or otherwise configured to receive information from the sensor(s) 102 and to use that information to control the power control hub 106. While not explicitly shown here, the controller may receive information from other sources (e.g., a radio transceiver) and/or be in communication with other energy harvester components, such as generator braking systems, actively powered stability control systems, lighting systems, communication systems, etc.

The power control hub 106 functions as a switching station including power electronic components and is configured to selectively connect, disconnect, or otherwise modulate a connection between the electrical load (e.g., power grid or storage system) and each one of the individual generators based on commands received from the controller 104. The controller commands may be based on data-driven models of energy harvester movement developed prior to deployment, including the expected moments imposed on the platform 18 by each of the individual generators over a range of rotational and oscillatory speeds and ranges of electrical loading. Based on real-time detection of pitch, roll, and yaw movements imposed on the energy harvester 10 by external natural fluidic flows, the controller 104 can determine the desired direction and magnitude of a counter-moment that will stabilize the harvester against those imposed movements and provide the power control hub 106 with a proper combination of electrical loads to place on each generator to achieve the counter moment. Data-driven models can provide continuous changes in electrical loads on each generator in response to continuously changing motion of the energy harvester. This is one example of stabilizing the motion of a floating energy harvester by modulating an impedance of at least one generator of the energy harvester.

In another simultaneous mode of operation, the controller modulates the impedance of at least one of the generators to affect the orientation of the energy harvester 10 with respect to the direction of the wind. As described above, a yawing moment can be imparted on the platform of the energy harvester by the hydrokinetic turbine generators 14a-14c. In particular, the controller 104 can impart a rotational speed differential among the multiple hydrokinetic generators to impart the yawing moment. This can be used to turn the wind turbine 12 into the wind based on real-time sensor information regarding wind direction or, if desired, turn the wind turbine 12 away from the wind. An intentionally applied yawing moment may also be used to turn an outer face of one of the wave energy converters 16 toward oncoming waves.

The disclosed energy harvester significantly reduces the levelized cost of energy (LCOE) over state-of-the-art offshore wind turbines by additionally capturing water current and wave motion energy at a small additional cost while leveraging the water motion-based generators to stabilize and orient the floating platform, which itself has a low implementation cost relative to offshore wind turbines that are anchored to the ocean floor or lakebed. The energy harvester also capitalizes on the fact that the energy density of moving water is highest at or near the water surface, making a floating platform an ideal implementation of water-actuated generators. It is noted that the particular generators disclosed here are only examples. There are numerous other types of water-actuated generators that can be used to convert water motion to electrical energy and whose resultant forces or moments on a floating platform can be controlled and used to provide stability or orientation changes to the energy harvester.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. An energy harvester that simultaneously generates electrical energy from more than one source of natural fluidic motion.

2. The energy harvester of claim 1, further comprising a first generator that generates electrical energy from wind and a second generator that generates electrical energy from natural water motion.

3. The energy harvester of claim 1, further comprising a wind turbine generator and a hydrokinetic turbine generator.

4. The energy harvester of claim 3, further comprising a controller configured to modulate an impedance of the hydrokinetic turbine generator to orient the wind turbine to face a wind direction.

5. The energy harvester of claim 1, further comprising a wind turbine generator and a wave energy generator.

6. The energy harvester of claim 1, further comprising a plurality of generators, each generator being configured to generate electrical energy from a different one of the sources of natural fluidic motion.

7. The energy harvester of claim 6, further comprising a controller configured to stabilize motion of the energy harvester by modulating an impedance of each generator.

8. The energy harvester of claim 7, wherein each impedance is modulated by modulating an electrical load on the respective generator.

9. The energy harvester of claim 7, further comprising at least one sensor that provides energy harvester motion information to the controller.

10. The energy harvester of claim 9, wherein the at least one sensor provides information related to pitch, roll, and yaw of the energy harvester.

11. A floatable energy harvester according to claim 1, further comprising:
a platform;
a plurality of electrical generators supported by the platform, including:
a wind turbine generator supported above the platform;
a plurality of hydrokinetic turbine generators supported below a water line of the energy harvester; and
a plurality of wave energy generators supported along a perimeter of the platform;
at least one sensor that continuously detects at least one direction of movement of the energy harvester; and
a controller that receives energy harvester motion information from the at least one sensor and modulates an electrical load on each generator to stabilize motion of the energy harvester,
wherein the controller modulates the electrical load on:
the wind turbine generator to stabilize pitching motion of the energy harvester;
the hydrokinetic turbine generators to stabilize pitching motion, rolling motion, or yawing motion of the energy harvester; and/or
the wave energy generators to stabilize pitching motion or rolling motion of the energy harvester.

12. The energy harvester of claim 11, wherein the controller modulates an impedance differential among the plurality of hydrokinetic turbine generators to change an orientation of the energy harvester.

13. A floatable energy harvester comprising at least one electrical generator, wherein each generator is controllable to stabilize energy harvester motion.

14. The energy harvester of claim 13, wherein the at least one electrical generator includes a plurality of hydrokinetic turbine generators that are individually controllable to change the orientation of the energy harvester with respect to wind direction.

15. The energy harvester of claim 13, wherein the at least one electrical generator includes a first generator that generates electrical energy from wind and a second generator that generates electricity from natural water motion.

16. The energy harvester of claim 13, wherein the at least one electrical generator includes at least two of: a wind turbine generator, a hydrokinetic turbine generator, or a wave energy generator.

17. The energy harvester of claim 13, further comprising a controller configured to modulate an impedance of each generator to stabilize energy harvester motion.

18. A method of stabilizing motion of a floating energy harvester by modulating an impedance of at least one electrical generator of the energy harvester.

19. The method of claim 18, wherein modulating the impedance includes modulating an electrical load on the at least one electrical generator.

20. The method of claim 18, further comprising:
modulating the impedance of a wind turbine generator to stabilize pitching motion of the energy harvester;
modulating the impedance of a hydrokinetic turbine generator to stabilize pitching motion, rolling motion, or yawing motion of the energy harvester;
modulating the impedance of a wave energy generator to stabilize pitching motion or rolling motion of the energy harvester; or
modulating an impedance differential among a plurality of electrical generators to affect an orientation of the energy harvester with respect to a wind direction.
